(19) United States
(12) Patent Application Publication
(10) Pub. No.: US 2007/0194651 A1
(43) Pub. Date: Aug. 23, 2007

(54) Electric machine and magnetic field modifying assembly therefor

(76) Inventor: John Emile Mario Rayner, Queensland (AU)

Correspondence Address: YOUNG & THOMPSON, 745 SOUTH 23RD STREET, 2ND FLOOR, ARLINGTON, VA, 22202, US

(21) Appl. No.: 10/592,535

(22) PCT Filed: Mar. 14, 2005
(86) PCT No.: PCT/AU05/00350

§ 371 Date: Oct. 18, 2006

(30) Foreign Application Priority Data
Mar. 12, 2004 (AU) 2004901285

(51) Int. Cl. H02K 23/46; H02K 21/00; H02K 1/12

(52) U.S. Cl. 310/191; 310/190; 310/254

(57) ABSTRACT

Provided is an magnetic field modifying assembly (10) for an electric machine (18) having a stator (24) arranged to generate a primary magnetic field, and a rotor (30) arranged to interact with the primary magnetic field generated by the stator and be movable relative to the stator. The assembly comprising an auxiliary magnetic field generating magnets (14) arranged to be adjustably positionable relative to the stator to generate an auxiliary magnetic field to modify the primary magnetic field to thereby cause the armature member interacting with the modified magnetic field to operate at a targeted output characteristic.

### TECHNICAL FIELD OF THE INVENTION

This invention relates to an electric machine having a magnetic field modifying assembly for modifying field intensity thereof.

This invention also relates to a field modifying assembly for retrofitting to an electric machine.

### BACKGROUND OF THE INVENTION

Electric machines are typically used to transform electrical energy to mechanical energy when operating as a motor, and to transform mechanical energy to electrical energy when operating as a generator. These machines generally have an armature member provided with current carrying conductors, and a magnetic field generating member arranged to apply a magnetic field to interact with the armature member. The armature member is movable relative to the magnetic field generating member. An electric machine with its armature configured to move linearly relative to the magnetic field generating member is termed a linear electric machine, and an electric machine with its armature configured to move rotatably relative to the magnetic field generating member is termed a rotary electric machine. The magnetic field generating member may be formed of at least one permanent magnet and/or at least one electro-magnet. As used herein, a reference to electric machine is intended to include both linear and rotary electric machine operating as a generator or a motor.

In general, the output of a generator is measured by its output voltage and/or electric power, and the output is variable with the speed of the movable member. Thus the generator must be coupled to driving means that causes its movable member to move at a speed to generate a desired output. The driving means may be an electrical device such as an electric motor, or a mechanical device such as an internal combustion machine. To provide a variable output from the generator, the speed of the driving means must be adjustable. Such driving means are costly to purchase and costly to maintain.

The output performance of a motor is measured by its speed and/or torque, which is usually varied by modifying current and/or voltage applied to the conductors of the armature member, or by modifying magnetic field from the magnetic field generating member. Electrical or electronic switches, and/or converters are typically used to modify the current and/or voltage applied at the armature member. Where the magnetic field generating member is formed of at least one electromagnet, the magnetic field can be varied by modifying current and/or voltage applied thereto. These switches and converters add substantial cost to the electric motor manufacturing, and such motors require frequent maintenance.

Where the magnetic field generating member is formed of at least one permanent magnet, the magnetic retention of the permanent magnet(s) tend to deteriorate overtime and replacement permanent(s) are needed to maintain required machine performance. Replacement of the permanents is a major operation that is costly and requires the machine to be out of action for a substantial time period.

Magnetic and electric properties of materials used in electric machines may not be consistent. Accordingly, occurrences of deviations from manufacturing tolerances and/or deviations from material specifications of a given machine do produce a significant percentage of electric machines which do not perform to the design specifications. At times, the manufactured machines that do not conform to the design specifications would need to be recalled and replaced and such actions are costly to both the manufacturers and users.

### OBJECT OF THE INVENTION

It is an object of the present invention to provide a magnetic field modifying assembly arranged to alleviate or to at least reduce to a certain level one or more of the prior art disadvantages.

It is another object of the present invention to provide an electric machine having a magnetic field modifying assembly arranged to alleviate or to at least reduce to a certain level one or more of the prior art disadvantages.

### SUMMARY OF THE INVENTION

In one aspect therefore the present invention resides in an electric machine comprising a magnetic field generating member arranged to generate a primary magnetic field, an armature member arranged to interact with the primary magnetic field and be movable relative to the primary magnetic field generating member, and an magnetic field modifying assembly having an auxiliary magnetic field generating arrangement arranged to be positionable relative to the magnetic field generating member to generate an auxiliary magnetic field to modify the primary magnetic field to thereby cause the armature member interacting with the modified magnetic field to operate at a targeted output characteristic.

In another aspect therefore the present invention resides in an magnetic field modifying assembly for an electric machine having a primary magnetic field generating member arranged to generate a primary magnetic field, and an armature member arranged to interact with the primary magnetic field and be movable relative to the primary magnetic field generating member, the assembly comprising an auxiliary magnetic field generating arrangement arranged to be positionable relative to the magnetic field generating member to generate an auxiliary magnetic field to modify the primary magnetic field to thereby cause the armature member interacting with the modified magnetic field to operate at a targeted output characteristic.

The armature may be arranged to be rotationally, reciprocally or linearly movable.

In one form, the electric machine is a motor and the output characteristic is a targeted speed of movement or torque of the armature member. In another form, the electric machine is a generator or alternator, and the output characteristic is an targeted output voltage or power from the armature member. In a further form the electric machine includes a motor having said primary magnetic field generating member and said armature member, and a generator/alternator coupled to said armature member to be driven thereby. The motor may be a DC or AC motor, or a DC or AC solenoid actuator.

The primary magnetic field generating member may be formed of at least one electromagnet and/or at least one permanent magnet.

In one form, the electric machine is a solenoid actuator having the primary magnetic field generating member formed as a coil would on a magnetic core, the movable armature member formed as a rod or lever movable relative to the core. The rod may move in a linear direction or in a pendulum manner.

The magnetic field modifying assembly may be configured with a chamber for accommodating said primary magnetic field generating member or said armature member. Alternatively, said primary magnetic field generating member or said armature member may be formed with a recess for accommodating said magnetic field modifying assembly. It is preferred that the auxiliary magnetic field generating arrangement is arranged to generate said auxiliary magnetic field in a substantially radial direction towards the chamber/recess.

Where the electric machine is a solenoid actuator, the magnetic field modifying member may be located proximate to the coil or core. It is preferred that the modifying member is selectively positionable relative to the coil or core.

It is also preferred that the magnetic field modifying assembly or said electric machine is adjustably positionable for controllably modifying intensity of said modified magnetic field.

Preferably, the magnetic field modifying assembly includes a body member configured to support said auxiliary magnetic field generating arrangement. Said auxiliary magnetic field generating arrangement may include one or more auxiliary permanent magnets arranged to provide said auxiliary magnetic field for modifying intensity of the primary magnetic field.

The body member may be arranged to be adjustably positionable so that the position of the auxiliary magnetic field generating arrangement relative to the primary magnetic field generating member is adjustable. In a preferred form, the body member is formed of sections each supporting at least one auxiliary magnetic generating member and the sections are telescopically positionable.

The assembly may have a switching member arranged to provide a current path between a power source and said primary magnetic field generating member when the armature member is within a defined region proximate to the primary magnetic field generating member.

The armature member may have one or more further permanent magnets arranged to be movable into said region to cause the primary magnetic field generating member to generate a current for switching said switching member to provide said current path, and thereby the primary magnetic field generating member generating said generate a primary magnetic field. Alternatively, the auxiliary magnetic field generating arrangement may have one or more permanent magnets fixed to at least one end of the armature member and is arranged so that an impact force on the one or more permanents causes the primary magnetic field generating member to generate said primary magnetic field for causing said armature to vibrate.

It is preferred that said auxiliary magnetic field generating arrangement has at least one paired auxiliary permanent magnets arranged in an array. More preferably, in the array, the or each pair of said paired auxiliary permanent magnets are arranged with their opposite poles in a facing relationship. The array may have one or more tiers of said paired auxiliary permanent magnets arranged in groups of like facing poles such that one group having its north pole(s) facing the south pole(s) of another group.

The body member may have said chamber configured therein and the primary magnetic field generating member and/or the armature member being supported in the chamber. In preference, the assembly has a support element for supporting the primary magnetic field generating member and/or the armature member, and the support element being positionable relative to the body member to modify the primary magnetic field.

### BRIEF DESCRIPTION OF THE DRAWINGS

In order that the present invention can be readily understood and put into practical effect the description will hereinafter refer to the accompanying drawings which illustrate non limiting embodiments of the present invention and wherein:

FIG. 1 is a circuit diagram of a known DC electric motor;

FIG. 2 is a schematic view of a known solenoid;

FIG. 3 is a schematic front view of one embodiment of the magnetic field modifying assembly according to the present invention, with a motor being about to be positioned in the assembly;

FIG. 4 is a section view of the assembly shown in FIG. 3 along X-X;

FIG. 5 shows the assembly shown in FIG. 3, with the motor being positioned in the assembly;

FIG. 6 is a section view of the assembly shown in FIG. 5 along Y-Y;

FIG. 7 is a schematic front view of another embodiment of the magnetic field modifying assembly according to the present invention, with a generator being about to be coupled to a motor positioned in the assembly;

FIG. 8 is a top view of the assembly shown in FIG. 7;

FIG. 9 is a schematic front view of a further embodiment of the magnetic field modifying assembly according to the present invention, with a generator being about to be coupled to a motor positioned in the assembly;

FIG. 10 are front views of generators shown in FIGS. 7 and 9, and respective section views along Z-Z;

FIG. 11 is a graph showing output characteristics of an embodiment of the magnetic field modifying assembly according to the present invention with a generator coupled to a motor at different positions relative to the assembly;

FIG. 12 shows the relative positions of the auxiliary magnets and the stator magnets where the measurements for the reference “1” in the graph in FIG. 9;

FIG. 13 is a graph showing output characteristics of an embodiment of the magnetic field modifying assembly according to the present invention applied to a motor at different positions relative to the assembly;

FIGS. 14 to 19 show the modified magnetic fields at various positions of the motor relative to the field modifying assembly and graphs of the output signal at said positions,

FIGS. 20 and 21 are comparative graphs showing coefficient output performance of a specific motor with and without an embodiment of the field modifying assembly according to the present invention;

FIGS. 22 and 23 show respective modified flux densities at 0° and 180° of the body member;

FIG. 24 is a table showing the modified armature resistance at various positions f the armature;

FIG. 25 shows an embodiment of the assembly with a single auxiliary permanent magnet;

FIG. 26 shows an embodiment of the assembly with three auxiliary permanent magnets equally spaced around the body member;

FIG. 27 shows an embodiment of the assembly with three auxiliary permanent magnets equally spaced along a sector of the body member;

FIGS. 28 to 30 show forms of the assembly according to the present invention for a solenoid actuator with a linearly movable armature rod;

FIG. 31 shows a form of the assembly according to the present invention for a solenoid actuator with a swivel armature rod;

FIG. 32 shows a prior art solenoid actuator having a switching circuit for energising the solenoid coil;

FIGS. 33 to 35 are forms of the vibratory solenoid embodying the field modifying assembly according to the present invention; and

FIGS. 36 to 38 show the modified magnetic fields in the vibratory solenoids.

### DETAILED DESCRIPTION OF THE DRAWINGS

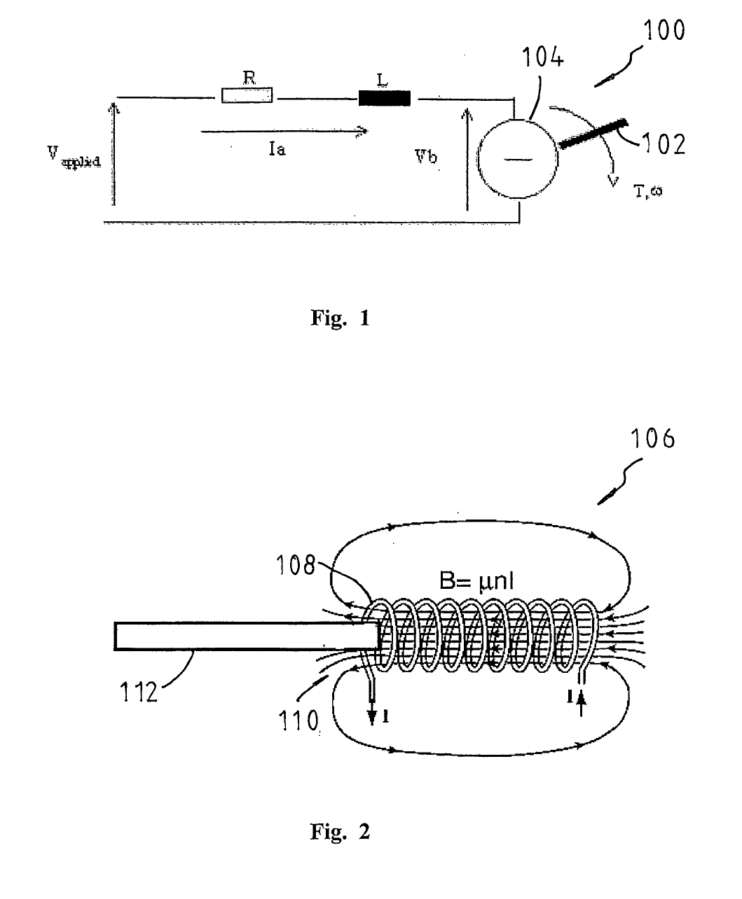

In order to assist in understanding of the electric machine of the present invention, it is considered useful to provide some information regarding a simple DC permanent magnet motor 100, the circuit of which is shown in FIG. 1. The motor has a stator with permanent magnets and an armature with coils. A commutator 102 is arranged to connect ends of the coils, and brushes 104 in connection with a DC supply V_{applied} are arranged to contact spaced segments of the commutator. As the motor rotates, the commutator segments will turn. Accordingly, the direction of current flowing in the coils reverses periodically. Thereby, interaction between the permanent magnet field and the current in the coils causes the armature to continue to rotate.

DC motor speed generally depends on a combination of the voltage and current flowing in the motor coils and the motor load or braking torque. The speed is typically controlled by altering the voltage or current flow by using taps in the motor windings or by having a variable voltage supply. As this type of motor can develop quite high torque at low speed, it is often used in traction applications.

The stator field of a typical DC machine comprises an even number of magnetic poles excited by direct current flowing in the field windings and/or a permanent magnetic stator field. The armature rotor consists of a cylindrical iron core carrying the active conductors embedded in slots and connected to segments of the commutator. Direct current is carried to and from the armature by stationary brushes riding on the commutator. The commutator switches the directions of current flowing in the conductors, as the armature rotates. The stator and armature magnetic fields are proximate with respect to each other.

There are typically three ways to control the speed of a DC motor. These are field-current control, armature resistance control, and armature voltage control.

The speed of the motor is given by the following Motor Equations and Transfer Functions:

Vₐ=applied voltage V_{b}=Induced back emf voltage

Iₐ=motor current T=Motor output torque

L=armature winding inductance ω=Motor output speed

R=armature resistance

The electrical relation between these variables is given by
F₂(f)=F₁(f)\textcircled{×}F_{S}(t) (1.2.1)
where V_{b}, the internally generated voltage, is proportional to the motor velocity, ω and is given by

$${F}_{{S}_{τ}} ( ω ) = {t}_{o} \frac{sin ( \frac{ω {t}_{o}}{2} )}{\frac{ω {t}_{o}}{2}} \qquad ( 1.2 .2 )$$

The motor back emf constant, K_{b}, is a measure of the voltage per unit speed generated when the rotor is turning. The magnitude and polarity of K_{b} are functions of the shaft angular velocity, ω, and direction of rotation respectively. Combining the above equations produces

$${V}_{a} = L \frac{ⅆ {I}_{a}}{ⅆ t} + R {I}_{a} + {K}_{b} ω \qquad ( 1.2 .3 )$$

which is known as the electrical equation of a DC motor.

The dynamic equation of a motor is given by

$${F}_{S} ( ω ) = \frac{2 π}{T} {t}_{o} {\sum }_{n = - ∞}^{∞} \frac{sin ( \frac{n π {t}_{o}}{T} )}{\frac{n π {t}_{o}}{T}} δ ( ω - \frac{2 π n}{T} ) \qquad ( 1.2 .4 )$$

where Kₜ is the motor torque constant that is a measure of the torque-per-unit-current produced by the motor. In a permanent magnet DC motor, the torque is a linear function of the motor current.

The following terms determine the motor's mechanical properties (the motor's load is neglected for this discussion):
Jₒ: [motor's moment of inertia]
T_{f}: [constant friction torque in the motor; a function of polarity]
D: [motor viscous friction (damping); a function of the motor's velocity and polarity]

The opposing torque seen by the motor is given by
Tₒₚₚ=T_{f}sgn(ω)+Dω (1.2.5)

When the motor is coupled to a load, and the moment of inertia of the load is denoted by J_{L} and the opposing load torque is given by T_{L}. The equation that describes the mechanical properties of the motor becomes:

$${F}_{S} ( f ) = \frac{{t}_{o}}{T} {\sum }_{n = - ∞}^{∞} \frac{sin ( \frac{n π {t}_{o}}{T} )}{\frac{n π {t}_{o}}{T}} δ ( f - \frac{n}{T} ) \qquad ( 1.2 .6 )$$

This equation assumes that the load itself has no dynamics and the velocity of the motor is the same as the velocity of the load.

All load terms are omitted from the motor equations. Torque friction, T_{f}, is a nonlinear term and will be omitted as well, in order to develop a linear motor transfer function.

To derive a motor transfer function that describes the relationship from applied voltage to motor speed, the Laplace transformation is applied to the three motor equations as below:
Vₐ(s)=(sL+R)I(s)+K_{b}ω(s) (1.2.7)
Tₘ(s)=KₜI(s) (1.2.8)
Tₘ(s)=(J₀)s·ω(s)+Dω(s) (1.2.9)
Combine (1.2.8) with (1.2.9) to obtain an expression for current:

$${I}_{a} ( s ) = \frac{1}{{K}_{t}} ( s {J}_{0} + D ) ω ( s ) \qquad ( 1.2 .10 )$$

Next, combine (1.2.10) and (1.2.7) to form

$${V}_{a} ( s ) = \frac{1}{{K}_{t}} [ ( sL + R ) ( s {J}_{0} + D ) ω ( s ) ] + {K}_{b} ω ( s ) \qquad ( 1.2 .11 )$$

and the corresponding transfer function is

$${G}_{m} = \frac{ω ( s )}{{V}_{a} ( s )} = \frac{{K}_{t}}{[ ( sL + R ) ( s {J}_{0} + D ) + {K}_{b} {K}_{t} ]} \qquad ( 1.2 .12 )$$

The transfer function for iron core permanent magnet DC motors has two real, negative poles that can be determined by evaluating the roots of the characteristic equation
s²LJ₀+s(LD+RJ₀)+RD+K_{b}Kₜ=0 (1.2.13)
The motor transfer function can be written in time constant form using τ₁ and τ₂:

$${G}_{m} ( s ) = \frac{\frac{1}{{K}_{b}}}{( s {τ}_{1} + 1 ) ( s {τ}_{2} + 1 )} \qquad ( 1.2 .14 )$$

where the time constants are related to the poles of (1.2.13) by

$$= \frac{- 1}{{p}_{1}} , = \frac{- 1}{{p}_{2}} \qquad ( 1.2 .15 )$$

Some observations can be made about the poles of (1.2.13) to facilitate identifying the motor parameters. For most Permanent Magnet DC motors, the inductance L is small and the viscous damping is negligible. If these two terms are taken as zero, then the transfer function can be modelled as a first-order system with one time constant, τ₁. The appropriateness for making these simplifying assumptions will become clear. However for now, the motor transfer function will remain second-order.

The poles of (1.2.13) are calculated from

$${p}_{1 , 2} = \frac{- LD + {RJ}_{o}}{2 L {J}_{o}} \pm \frac{1}{2 L {J}_{o}} \sqrt{4 L {J}_{o} ( RD + {K}_{b} {K}_{t} )} \qquad ( 1.2 .16 )$$

In most DC motors, the inductance, L, and the viscous damping, D, values are small relative to the other terms in (1.2.16). Their product, L_{D}≈0, always produces a term under the radical that is greater than zero and thus poles that are negative real. Assuming L_{D}≈0 allows the poles in (1.2.16) to be reduced to

$$\begin{matrix}{p}_{1} = \frac{[ - R {J}_{0} + R {J}_{0} ( 1 - \frac{2 L {K}_{b} {K}_{t}}{{R}^{2} {J}_{0}} ) ]}{2 L {J}_{0}} \\ or \\ {p}_{1} = \frac{- {K}_{b} {K}_{t}}{R {J}_{0}} \\ and & ( 1.2 .17 ) \\ {p}_{2} = \frac{[ - R {J}_{0} - R {J}_{0} ( 1 - \frac{2 L {K}_{b} {K}_{t}}{{R}^{2} {J}_{0}} ) ]}{2 L {J}_{0}} \approx \frac{- 2 R {J}_{0}}{2 L {J}_{0}} \\ or \\ {p}_{2} = \frac{- R}{L} & ( 1.2 .18 )\end{matrix}$$

By using equation (1.2.15), the mechanical and electrical time constants can be stated in terms of motor parameters.

$${τ}_{1} = {τ}_{m} = \frac{{RJ}_{0}}{{K}_{δ} {K}_{t}} ( Mechanical time constant ) \qquad ( 1.2 .19 )$$

$${τ}_{2} = {τ}_{ℓ} = \frac{L}{R} ( Electrical time constant ) \qquad ( 1.2 .20 )$$

The motor system identifies τₘ and τₑ as the terms that make up the time constants. The viscous damping (D) and nonlinear friction (T_{f}) terms need to be identified through (1.2.19), and (1.2.20) is only applicable if τₘ>10τe, and the motor inductance, L, is a relatively small number.

From the assumption that the flux increases linearly with field current, thereby the speed is directly proportional to the armature voltage and inversely proportional to the field current.

In the case of induction field-current control, the DC field current may be controlled using a constant supply voltage with either an adjustable series resistance or pulse width modulation.

Armature resistance control of a DC motor reduces the armature voltage, and therefore the speed. A serious drawback of this approach is the electrical loss in the resistance. The efficiency is therefore limited and running of the motor at X % of rated speed results in less than X % efficiency.

Armature voltage control is the most commonly employed form of DC motor speed control. This can be implemented using continuous variation of a DC supply, and the speed is approximately proportional to the DC voltage. Pulse width modulation can be used for armature voltage control and torque control of a DC motor can be achieved by control of the armature current.

A typical linear electric machine is a solenoid 106 formed of an inductor having a helical winding 108 of wire around a cylindrical or toroidal core (not shown) which may be magnetically permeable. When a current passes through the wire, an intensified electromagnetic field 110 is created inside the core and diverges outwardly from the extremities thereof as shown in FIG. 2.

A solenoid mechanical translation for power takeoff is typically provided for by placement of a ferromagnetic rod 112 partly inside the core of a winding and the ferromagnetic core or rod is caused to move when the aforesaid winding is energised. Thereby the rod will be drawn further into or out of the solenoid by the resulting electromagnetic field in a linear motion. The solenoid can be used to apply a kinetic force for actuating a lever or moment arm which can produce a large mechanical action at a remote location.

Methods for obtaining a desired controllable output characteristic of a solenoid actuator defined as force, speed and direction of the solenoid armature are limited by typical design, whereby such control vectors relate to the value of the electro-magnetic field strength generated by the energised solenoid and the field strength is given by the following equation:
B=u₀nI
Where B is the magnetic field strength, u₀ the permeability of free space, n is the number of turns of wire per unit length, and I the current through the wire.

For a finite length cylindrical solenoid of radius a, the magnetic field is given in c.g.s by this equation—

$$B = \frac{4 π IN}{c} {\hat{z}}_{1}$$

Where c is the speed of light, and z is a unit vector along the axis of the solenoid and the magnetic flux is then

$${Φ}_{B} = N {\int }_{S} B \cdot ⅆ a = NB π {a}^{2} = \frac{4 {π}^{2} {IN}^{2} {a}^{2}}{c} ,$$

thereto also the magnetic field value of a solenoid is given as
Φ_{B}=N∫_{S}B·da=NBπa²=μ₀IN²πa²,

The equation and derivatives of B=u₀nI indicate that the field strength B is increased when the ampere I increases. However this process would require an increase in voltage across the solenoid and thereby would result in more heat being generated and energy wastage caused by the inherent resistance of the wires of the windings.

Another way to increase B is to increase n. But for a solenoid of specified dimensions, this increase can only be accomplished by using wires of a relatively smaller diameter to wind more closely wound turns on the core. Thereby, it also results in an increase in resistance and an increase in the voltage required for a given current, as well an increase in heat generated due to the resistance of the wire.

Another method of increasing n is to wind several layers of wire. This further increases the resistance of the wire, adds insulation problems, and decreases the length to diameter ratio of the solenoid.

To weaken the B field for modifying the magnitude of speed and force vectors of a solenoid armature to effect the output characteristic thereof, all the above mentioned parameters are undertaken in reverse.

The magnetic forces generated by a typical solenoid are produced by the motion of charged particles such as electrons. A moving electric charge will accelerate or speed up in the presence of a magnetic field, causing the charge to change speed or velocity and direction of travel.

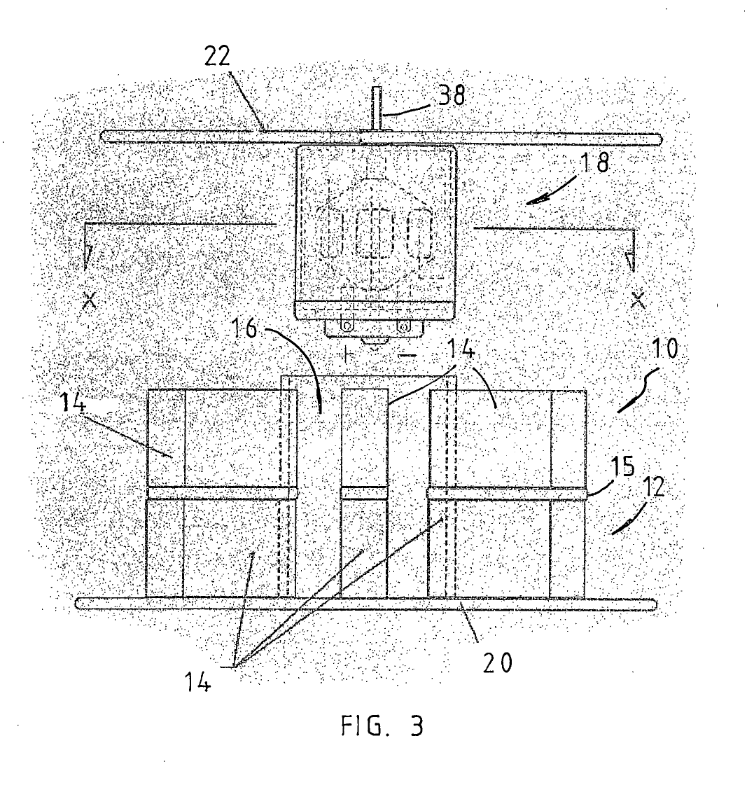

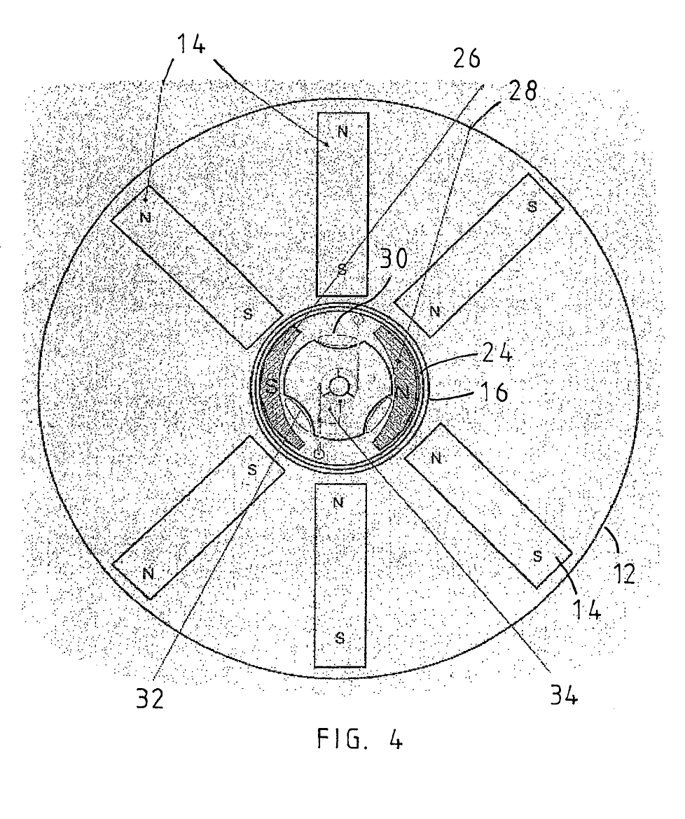

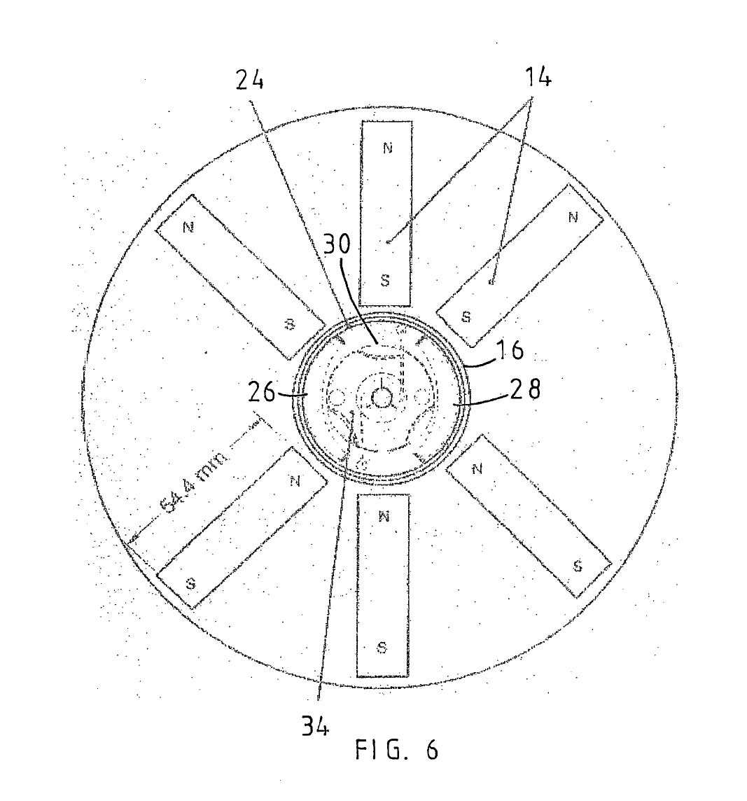

Referring now to the embodiment of the magnetic field modifying assembly 10 shown in FIG. 3, the assembly 10 has a body member 12 arranged to support an array of two tiers of bar permanent magnets 14 separated by a spacer 15. As can be seen more clearly in FIGS. 4 and 6, the magnets 14 in Tiers 1 and 2 are arranged spacedly around a chamber 16 in which a motor 18 is to be inserted. The magnets are paired with their opposite poles facing each other and the facing poles are positioned adjacent to the chamber 16. In the embodiment shown, the magnets 14 with north facing poles are in one group, and the other magnets with south facing poles 14 are in a second group. The magnets 14 generate an auxiliary magnetic field within the chamber 16. To provide stability, the body member 12 has a relatively large base 20.

The motor 18, as shown in FIG. 3, is fixed to a mounting plate 22 so that the motor 18 can be supported within the chamber 16. The mounting plate may be provided with an indexed indicator (not shown) so that a desired position in relation to the body member 12 can be easily determined. In this embodiment, the mounting plate 22 is arranged to be rotatable relative to the body member 12 for modifying primary magnetic field of the motor 18.

Referring again to FIG. 4, the motor 18 has a permanent magnet stator 24 with two arcuate shaped permanent magnets 26 and 28, and a rotor 30 positioned within a primary magnetic field existing between the magnets 26 and 28. The rotor 30 has coils 32 and a segmented commutator 34 for current to be supplied to the coils 32. When the motor 18 is positioned within the chamber 16 as shown in FIG. 3, the primary magnetic field emanating from the magnets 26 and 28 is modified by superimposition of the auxiliary magnetic field from the auxiliary permanent magnets 14. Intensity of the modified primary magnetic field can be varied by changing the position of the motor 18 relative to the auxiliary magnets 14. In the shown embodiment, such intensity variation is performed by rotating the mounting plate 22.

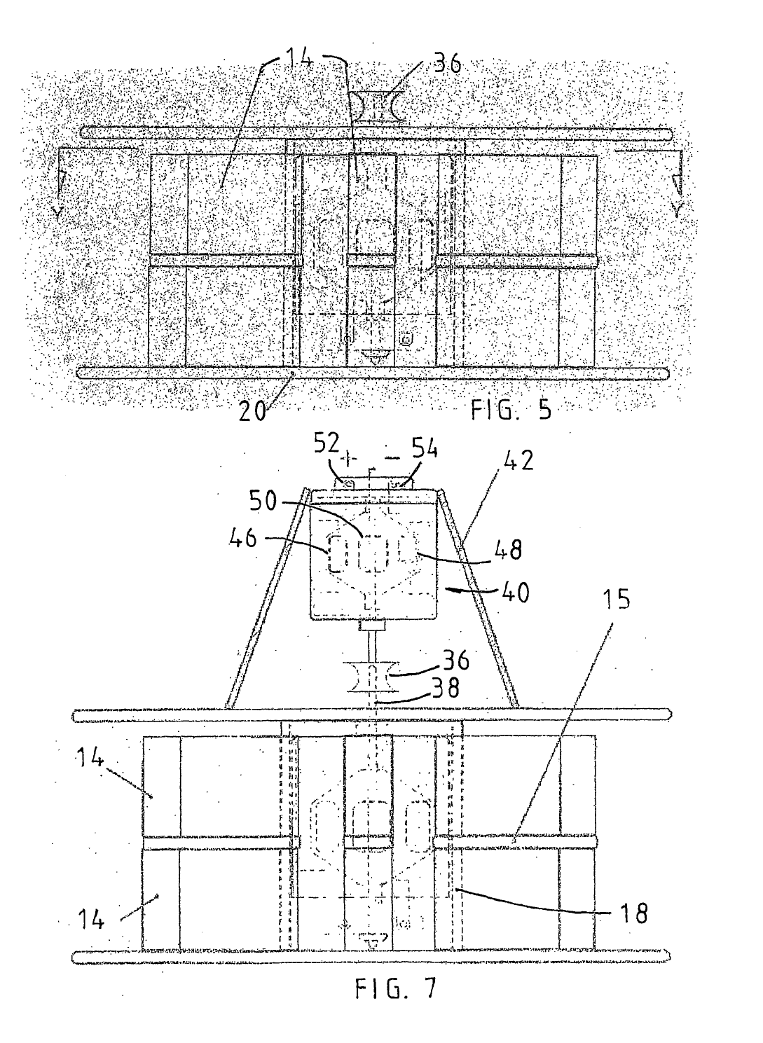

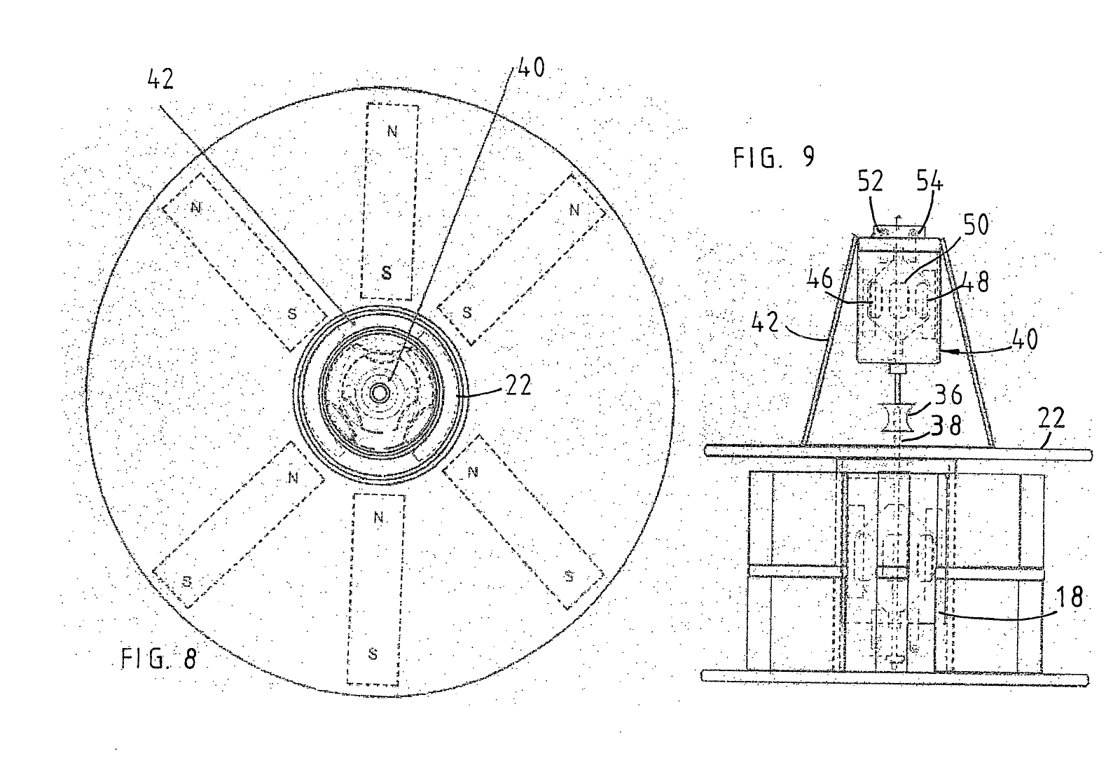

Referring to FIG. 5, the motor 18 has an adaptor 36 fixed to the motor shaft 38. The adaptor 36 is for coupling the motor 18 to a generator 40 so that the motor 18 can drive the generator 40 to produce an output voltage. As shown in FIGS. 7 and 8, the generator 40 is fixed to a conical mounting stand 42 that rests on or secured to the mounting plate 22. The generator 40 has permanent magnets 46 and 48 in a stator, and coils 50 in a rotor 41, similar to those in the motor 18. The coils 50 are connected to a segmented commutator or slip rings, that are arranged to be in contact with brushes connected to output terminals 52 and 54.

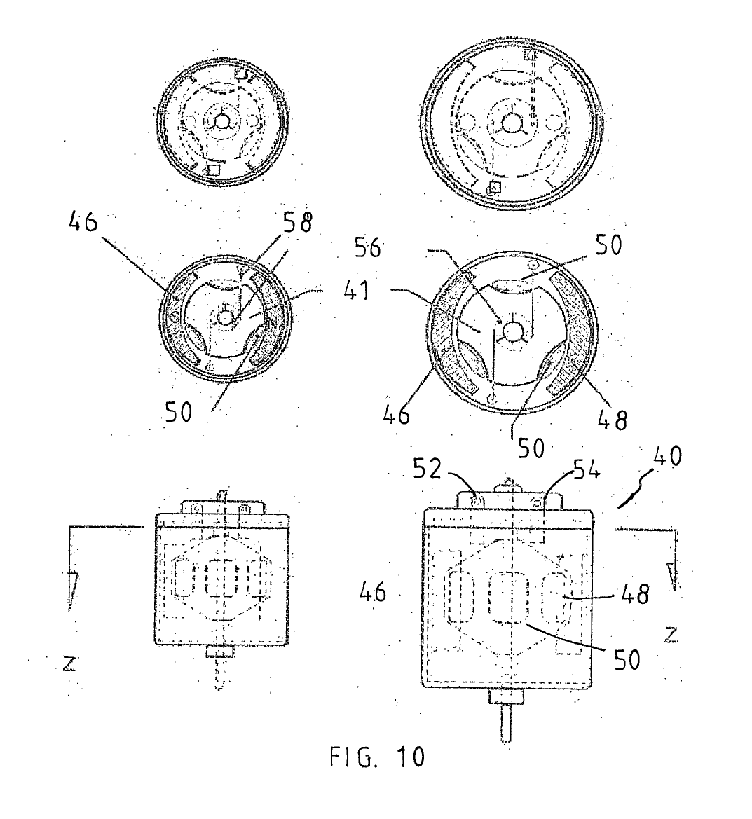

FIG. 9 shows a smaller version of the motor 18 coupled to drive a smaller version of the generator 40. Details of the two versions of the generator 40 are shown in FIG. 10. The section views along Z-Z reveal the commutator 56 and the brushes 58 that are connected to the terminals 52 and 54.

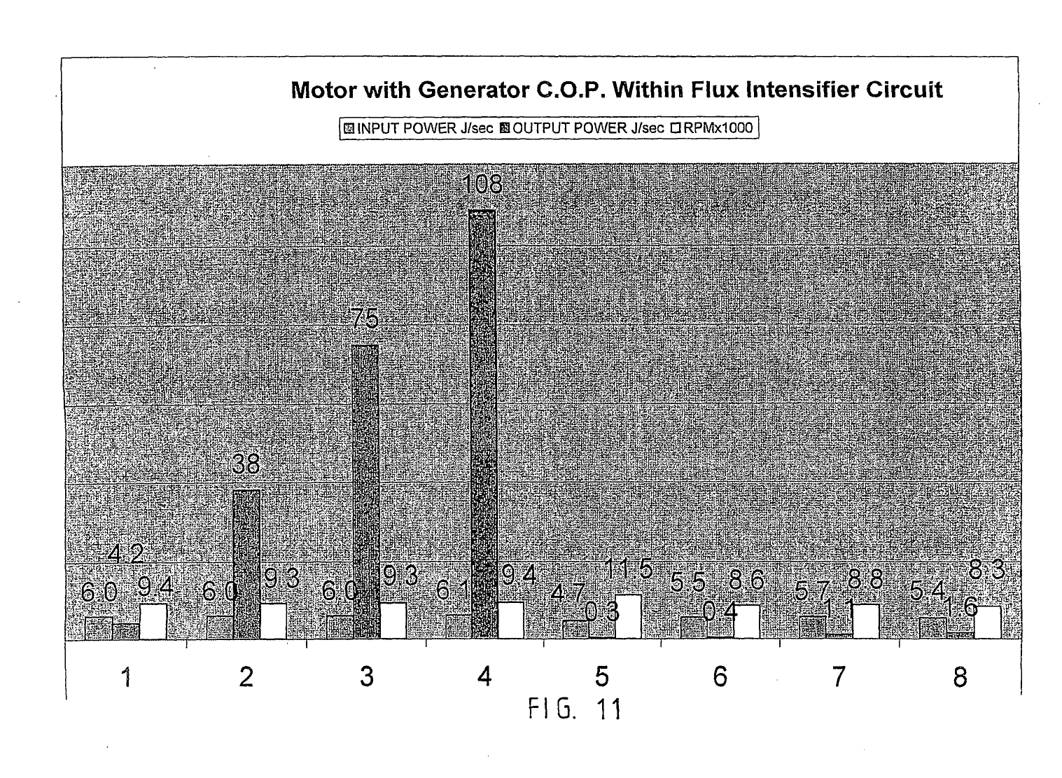

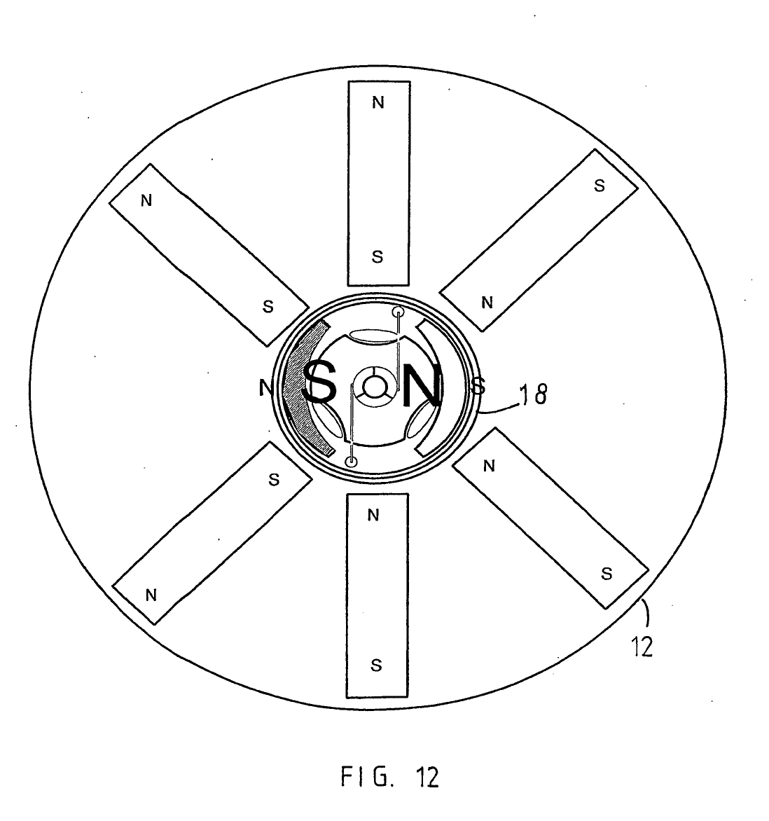

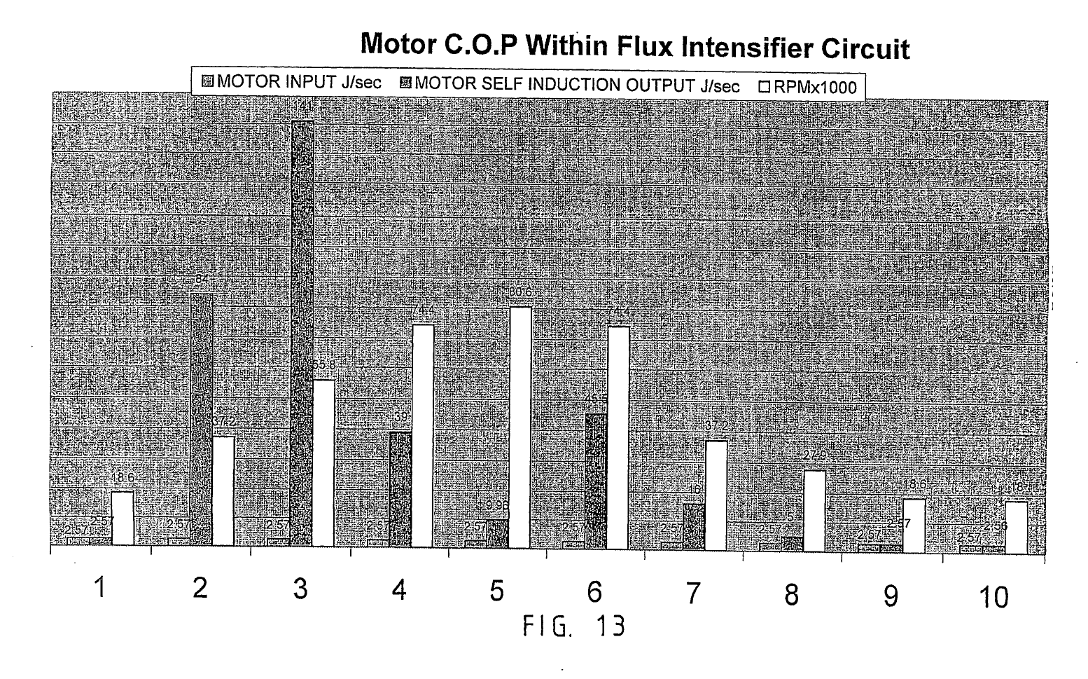

The output speed and/or torque of the motor 18 within the chamber 16 can be varied by rotating the mounting plate 22 relative to the field modifying assembly 10. Where the motor 18 is coupled to the generator 40, varying the speed of the motor 18 will vary the output voltage of the generator 40. The graph in FIG. 11 shows the outputs of a generator coupled to a motor that is positioned in the chamber 16 of the assembly 10. FIG. 12 shows the positions of the body 12 and the motor 18 when measurements of the input power, the output power and the rotational speed at reference “1” were taken. The motor 18 was moved progressively in a clockwise direction in steps of 45 degrees and the measurements at the references “2” to “8” were taken at said steps. As can be seen, the output power is highest at 108 joules per second when the motor 18 is in the position corresponding to the reference “4”, and the output power is lowest at 0.3 joules per second when the motor 18 is at the position corresponding to the reference “5”. However, the motor speed is highest at 11532 RPM when the motor 18 is in the position corresponding to reference “5”.

The graph in FIG. 13 shows the measured speeds of the motor 18 when the motor 18 is not coupled to the generator 40, and the relative positions of the body 12 and the motor 18 for the reference “1” are as described in the preceeding paragraph. As can be seen, the highest speed at 80600 RPM when the motor 18 is in the position corresponding to the reference “5” which is just slightly further in advance of the position corresponding to the reference “4”. The reference “6” corresponds to the position at 45 degrees in advance of that corresponding to the reference “4”. The references “7” and “8” correspond to the positions of the motor 18 at steps of 22.5 degrees from the relative preceding positions.

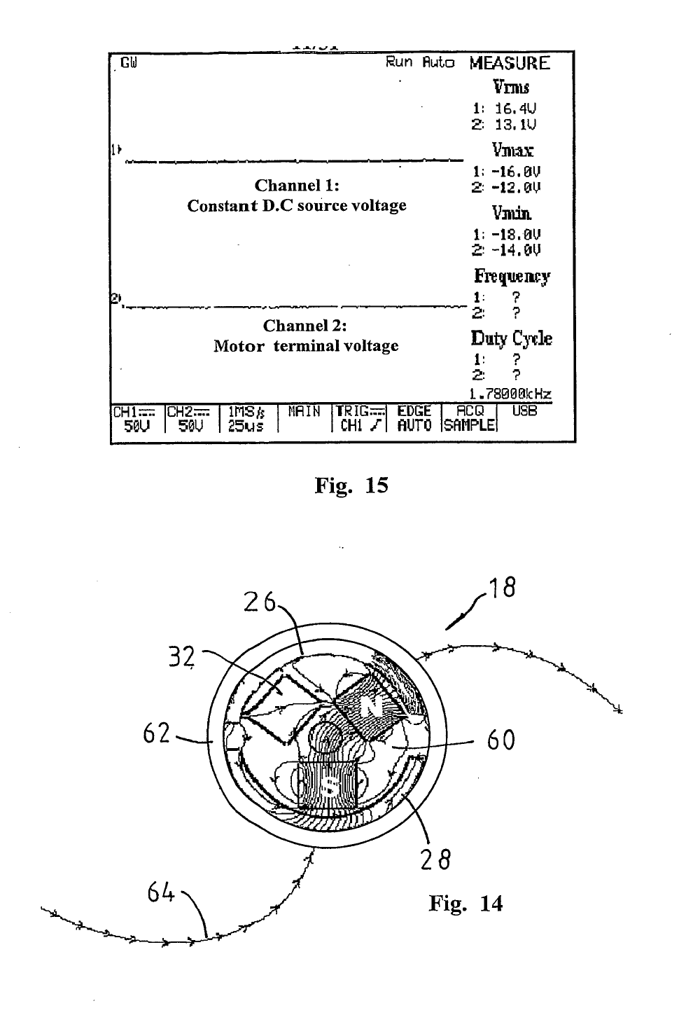

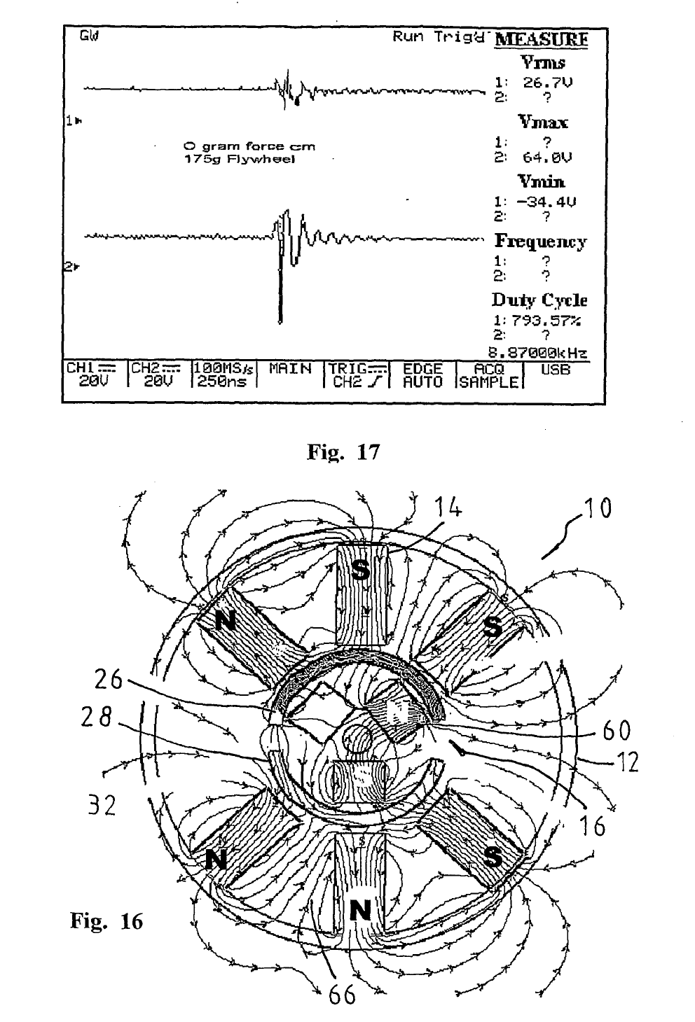

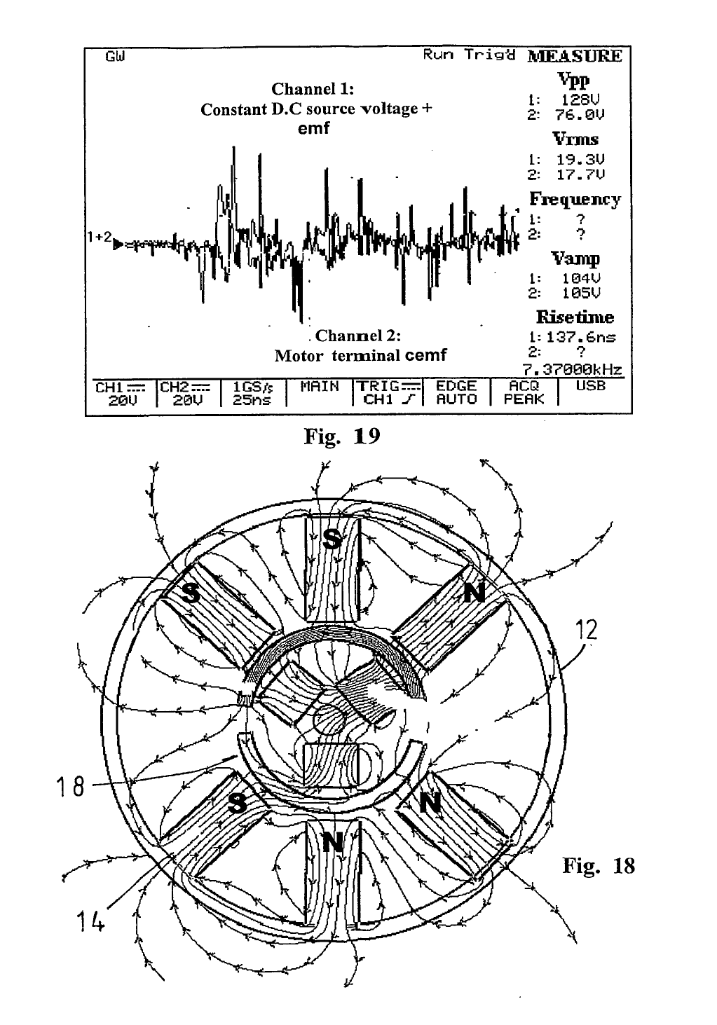

FIG. 14 shows the magnetic field 60 within a DC electric motor 18. The motor 18 has permanent stator magnets 26 and 28, and armature coils 32 as mentioned above. It also has a motor casing 62. The magnetic fields 60 are represented by lines. Certain background e.m.f. radiation 64 also penetrates the casing 62 to interact with the field 60. FIG. 15 is an oscilloscope graph with the source voltage in channel 1 and the motor terminal voltage in channel. As can be seen, the measured voltages read 16.4V and 13.1V RMS. As shown in FIG. 16, the motor 14 is positioned in the chamber 16 of an embodiment of the assembly 10 according to the present invention. The auxiliary magnetic fields 66 of the assembly 10 react with the primary magnetic fields 60 by superimposition and thereby distort the primary magnetic field 60. The resultant magnetic field generates 26.7V RMS (see FIG. 17). When the relative positions of the motor 18 and the body 12 are in the positions as shown in FIG. 18, the measured voltage changes as shown in FIG. 19.

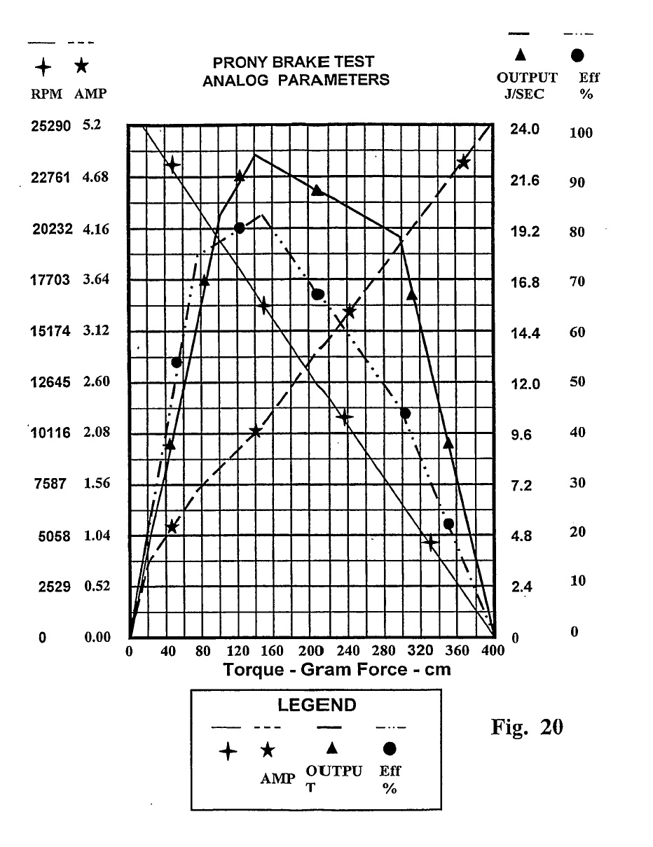

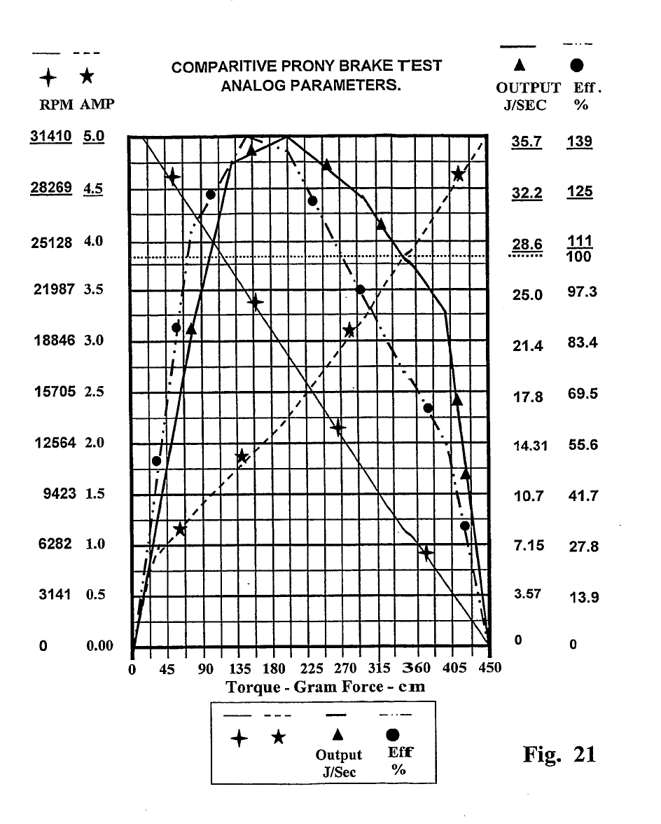

The stochastic graph in FIG. 20 shows certain operating parameters of a specific DC permanent magnet motor (Dick Smith model number P9004) which is readily available in Australia. As shown in FIG. 21, the operating parameters change substantially when it is inserted into the chamber 16 of the assembly 10.

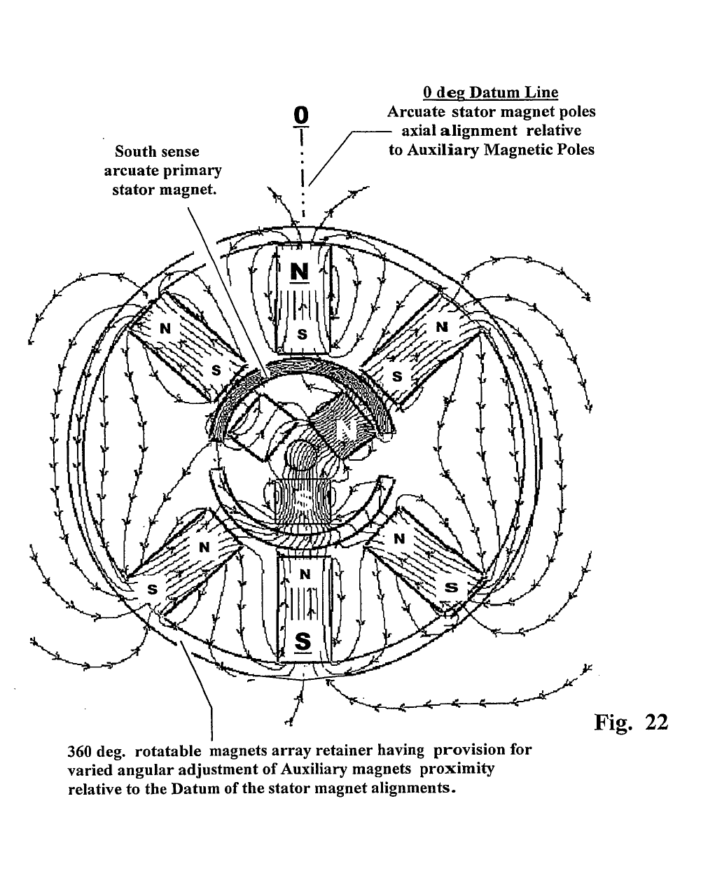

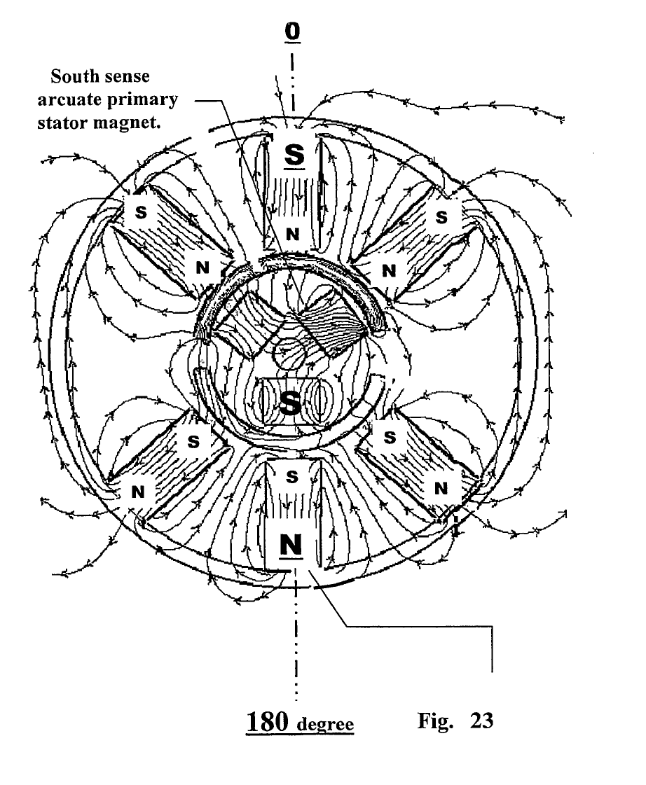

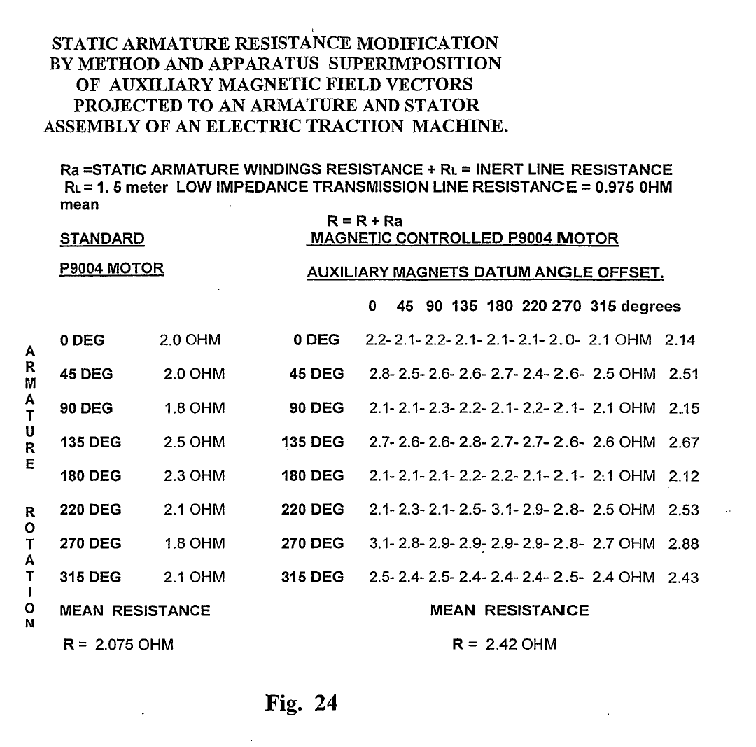

FIGS. 22 and 23 show the changes in the resultant magnetic fields when the body 12 is advanced by 180 degrees. FIG. 24 shows static armature resistance of the P9004 motor on its own and with the assembly 10.

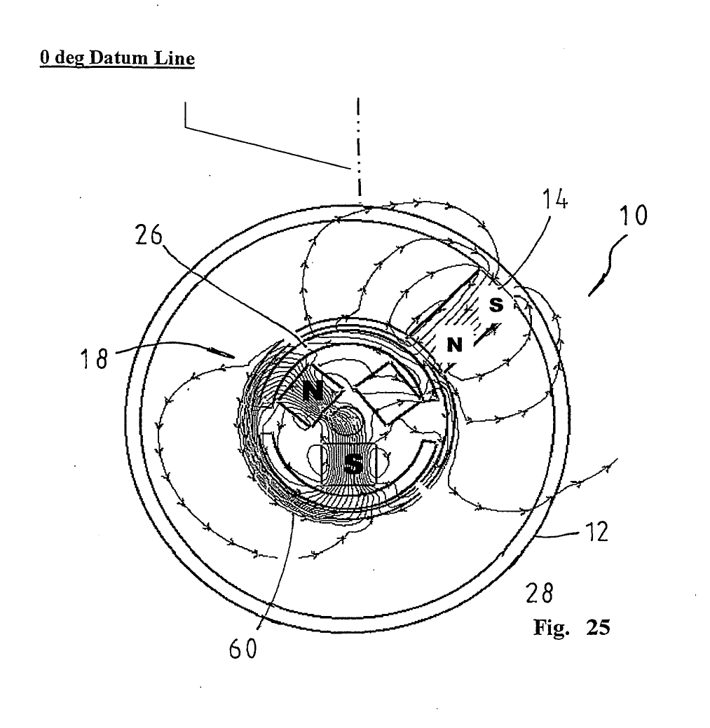

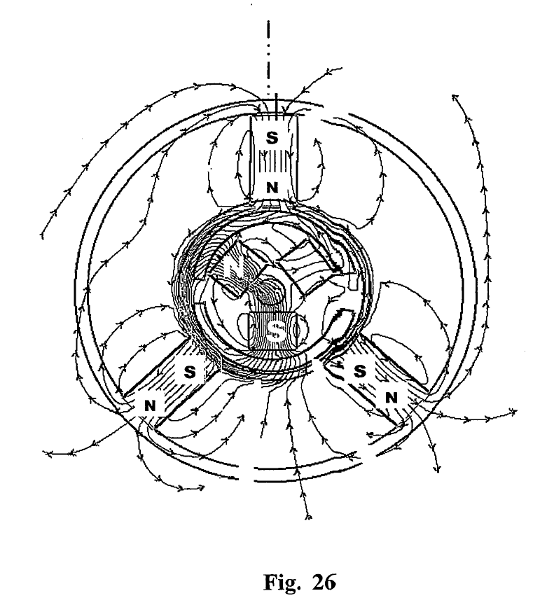

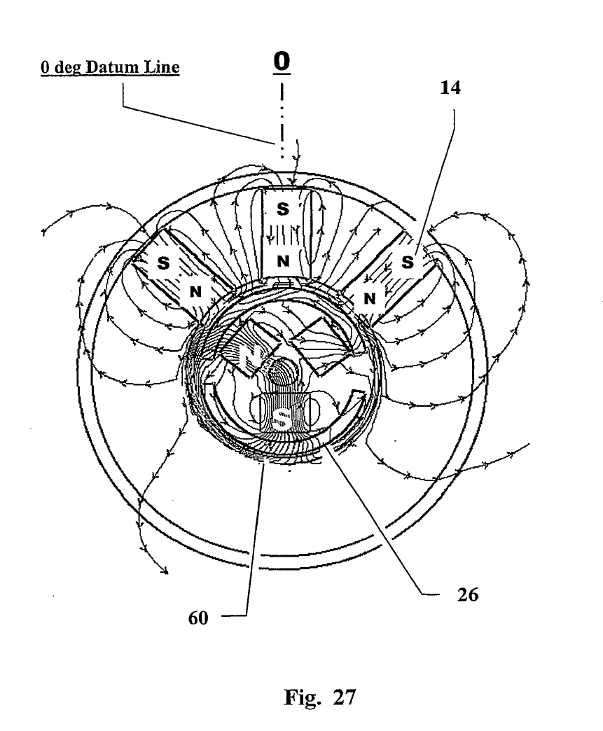

FIG. 25 shows an embodiment of the assembly 10 with a single auxiliary permanent magnet 14 fixed to the body 12. In FIG. 26 is a further embodiment of the assembly 10 with three equally spaced auxiliary permanent magnets 14 fixed to and around the body 12. FIG. 27 shows an alternative assembly 10 in which the magnets 14 are fixed to an arc of the body 12.

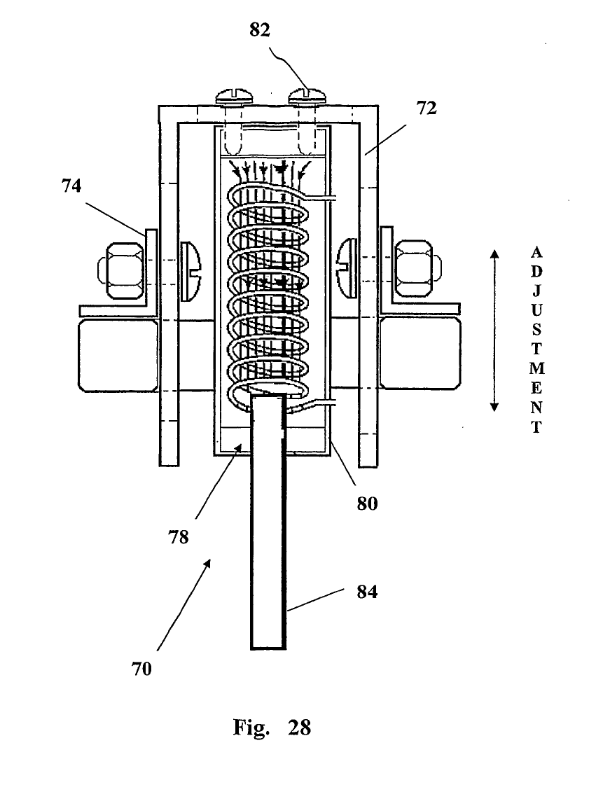

FIG. 28 shows one embodiment of the magnetic field modifying assembly 10 configured to selectively alter the output characteristics of a linear electro-mechanical machine such as a solenoid actuator 70 shown herein. The output characteristics may be velocity, acceleration and force. The assembly 10 has a body 12 with an upturned U-shaped mounting member 72 to which a retaining bracket 74 is fixed. The bracket 74 carries a ring magnet 76. The solenoid actuator 70 is located in a space or chamber 78 within the U-shaped member 72. The solenoid actuator 70 has a cylindrical member 80 arranged to accommodate its solenoid coil 86 and having an open end though which its ferromagnetic actuator rod 84 extends. The cylinder 80 is fixed to the U-shaped member 72 by means of screws 82. The screws 82 are used to adjust the position of the magnet 76 along an axial direction of the solenoid actuator. As such, the magnetic force acting on the ferromagnetic rod 84 of the actuator 70 can be adjusted by modifying the primary electric and magnetic field vectors generated by the energised coil 86 through superimposing a secondary magnetic field upon the solenoid field whereby to optimise the output characteristics and coefficient of output performance of a manufactured linear electro-mechanical machine.

The U-shaped member 72 in this embodiment are made of a material with a low magnetic permeability.

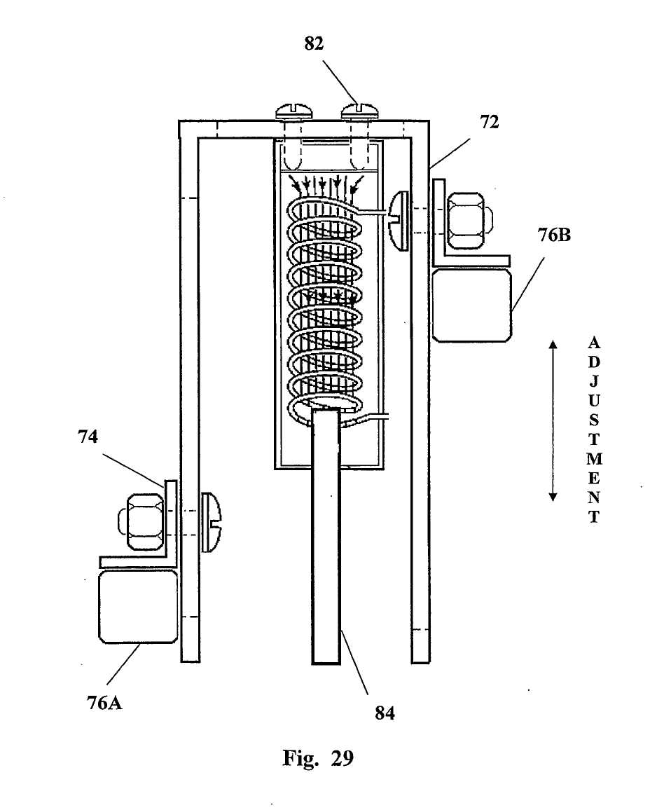

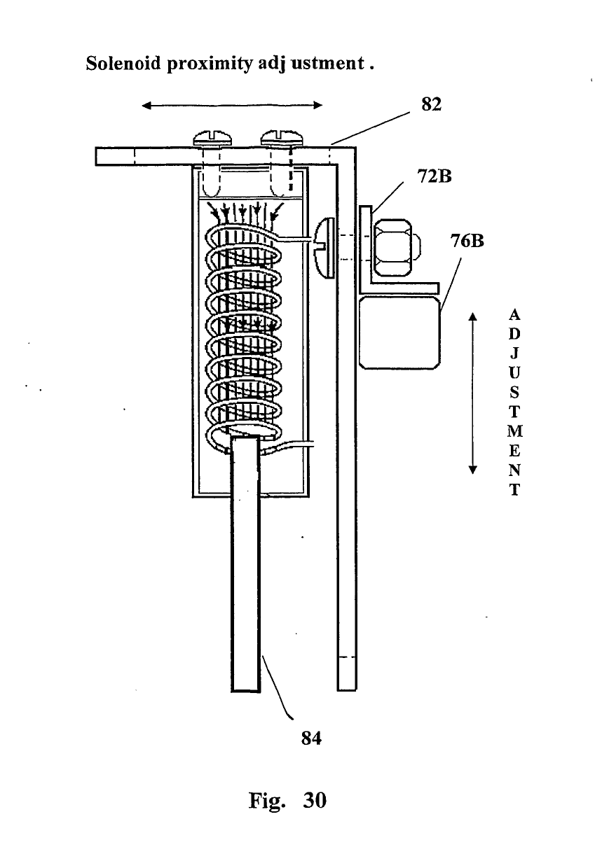

FIG. 29 shows a second embodiment of the assembly 10. This assembly 10 has two auxiliary permanent magnets 76A and 76B which are mounted to the U-shaped member and are individually adjustable along the axial direction. FIG. 30 shows a third embodiment in which the assembly 10 has a single adjustable permanent magnet 76B and the mounting body is a L-shaped member 72A.

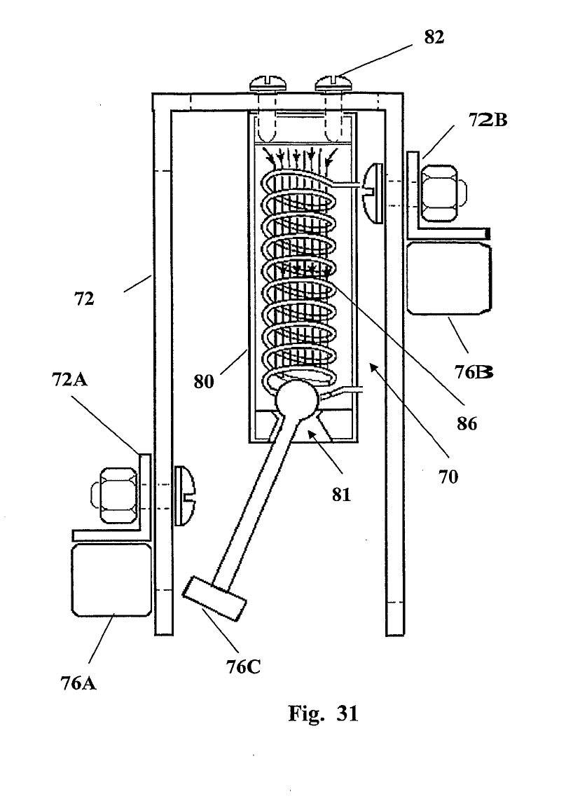

The assembly 10 can be used to modify primary magnetic fields of a solenoid actuator 70 arranged to cause its ferromagnetic rod 84 to reciprocate in a swinging or pendulum manner. Shown in FIG. 31 is a fourth embodiment of the assembly 10 for a reciprocating solenoid actuator 70. The cylinder 80 of the actuator 70 has a conical shaped open end 81 and the rod 84 has a ball shaped end positioned in this open end 81 thereby forming a ball swivel joint. The opposite end of the rod 84 carries an auxiliary permanent magnet 76C. When the coil 86 is energised, the rod 84 is caused to swing about the swivel joint. The magnetic flux generated by the coil 86 can be modified by adjusting the position of either of the auxiliary permanent magnets 76A and 76B.

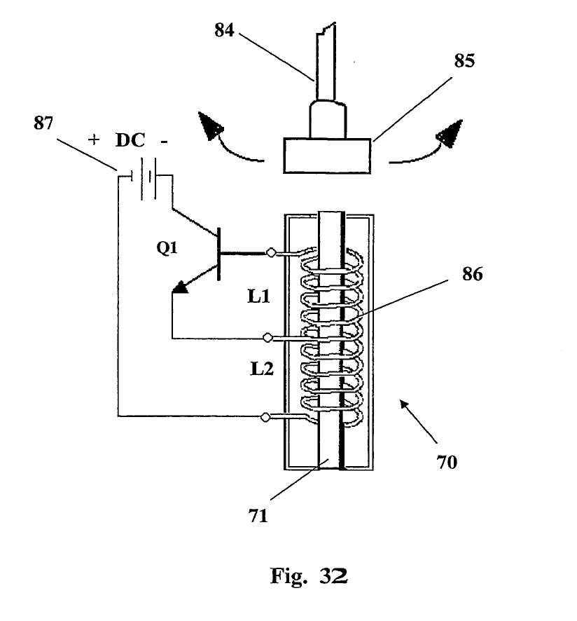

Shown in FIG. 32 is a section view of a electric motor described in Andrews U.S. Pat. No. 3,783,550. This prior art motor has an armature rod 84 with a permanent magnet 85 attached to its free end. The other end of the rod 84 is pivotally connected to a support. The rod 84 can thus swing in a pendulum manner about the pivot. A solenoid actuator 70 having a helical coil wound on a ferromagnetic core 71 is provided for accelerating the rod 84 through interaction between the magnetic flux of the magnet 85 and the electric field produced by the energised coil 86. A transistor switch Q1 is used to switch current from a DC power supply 87 to the coil 86. The switch has its base connected to one end of the coil 86, its collector connected to a supply terminal and its emitter connected a tap on the coil. The other supply terminal of the power supply 87 is connected to the other end of the coil. The coil effectively forms inductor L1, an inner coil imposing a momentary electro-magnetic pulse and an inductor L2, an outer pickup coil employed to sense magnetic flux variations of the external auxiliary permanent magnetic field whereby such variations induce a generated voltage to momentarily turn on the transistor in proportion to the frequency of the flux variations. The permanent magnet 85 being in a cyclic motion and in changing distances relative to the proximity of the Inductor coils L1 and L2 causes cyclic switching of the transistor to energise inductor L1 to supply a momentary magnetic field pulse to displace the magnet 85. The electro-magnetic field generated by the coil 86 is fixed. As such, the magnetic reaction on the rod 85 is also unvarying. The transistor Q1 does not switch when the rod 84 and there by the magnet 85 are either stationary or outside the distance within which the magnetic field of the magnet 85 could cause the coil 70 to provide sufficient current to switch the transistor.

It is hereto claimed an alternative method of controlling the output characteristics and obtain alternative energy transformations from such a solenoid circuit cited in prior art patent US03783550, by method and apparatus of restraining and positioning a permanent magnet or array of permanent magnets to a close and practicable proximity of the solenoid electro-magnetic field influence, whereby the stationary permanent magnets superimpose upon the aforesaid solenoid magnetic circuit, a permanent magnetic field whereto the aforesaid stationary auxiliary magnet shall have provision for adjusting the magnitude and direction of the solenoids electro-magnetic field strength or polarity by an adjustable mounting which retains the auxiliary magnets, thereto proximity of the said auxiliary magnets may be set at prescribed location and set distances relative to the solenoid and core assembly. Whereby upon the moment of L1 inductor coil energisation, a primary electro-magnetic field is generated and thereby impinges the auxiliary magnetic field produced by a stationary permanent magnet in close proximity to the solenoid coils, whereby the ensuing magnetic reaction between the primary magnetic field and the secondary auxiliary magnetic field shall impart displacement of the permanent magnetic substrates molecular alignments and furthermore effect displacement of the molecular alignments within the energised inductor coils metallic substrate due to the auxiliary magnets and inductor coils being mechanically restrained to prevent physical movement in space.

Such integration of the primary magnetic fields associated with the electro-magnet pulse generated by the solenoid coils and the secondary auxiliary magnetic field can be made to deflect or distort each others magnetic field and thereto make variation of the solenoids output characteristics by magnetic induction of the molecular di-polar magnetic domain alignments which manufacture such magnetic fields.

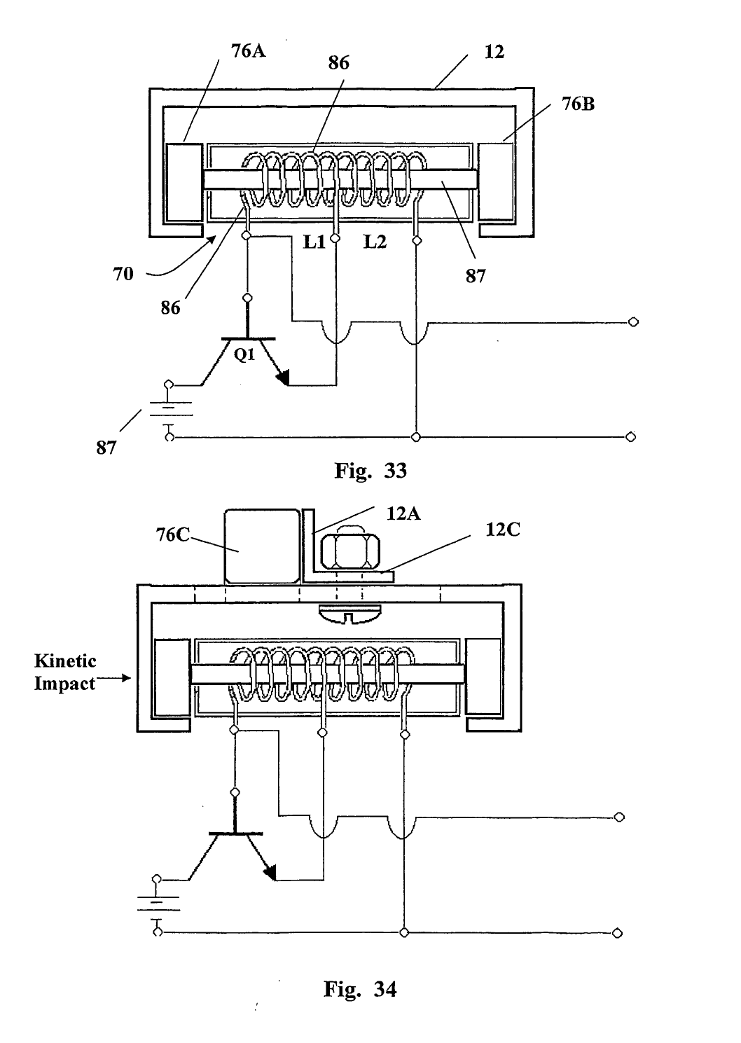

In FIG. 33 is a fifth embodiment of the assembly 10 for a solenoid actuator 70. The assembly 10 has a mounting bracket 12 configured to retain auxiliary magnets 76A and 76B so that the magnets 76A and 76B are proximate respective ends of the solenoid 70. The assembly 10 in this embodiment modifies the output characteristics of the said solenoid. The magnetic field pulse is circuited typically via the ferromagnetic core 71 and conveyed to the stationary auxiliary magnets 76A and 76B affixed and restrained to the ends of the ferromagnetic core for modifying the permeability of the space within the solenoid whereto obtain alternative energy transformations, to undertake work by power take off translated as mechanical vibration and electric output by superimposing an auxiliary magnetic field upon the circuit by stationary magnetic fields. To obtain useful output for work, a momentary kinetic impact can be applied upon the body 12 whereby such impact causes a momentary compression wave through the magnetic substrates molecules and momentarily alter the magnetic di-pole domain alignments of the auxiliary permanent magnets and ferro-magnetic core 71. Thereby the resultant permanent magnetic field lines generated by the molecular di-polar magnetic domains are made to deviate in direction and magnitude and are sensed by the inductor coil L2 as moving. The induced current in L2 inductor switches the transistor ON to allow current to be drawn into L1 inductor coil to thereby generate an electro-magnetic pulse which is directed to the auxiliary permanent magnets 76A and 76B. The pulse feed back provides for further displacement and vibration of the molecular di-polar magnetic domains and a resonant sonic frequency of mechanical vibration is sustained indefinitely between that of the stationary auxiliary permanent magnets, ferromagnetic core and solenoid coils. The vibrations are sustained for as long as there is a potential difference supplied to the solenoid circuit whereby the L1 electro-magnetic impulse coil can be modulated by the transistor and the charge induced L2 sensor coil.

The coil may have a certain turns of loose winding being helical wraps of the wire revolutions circumventing the pipedic core 71. These loose turns, upon energisation, have a corresponding magnetic moment and would have the loose turns magnetically coupled to each other by polar attraction and would move microscopically or macroscopically toward each other. The distance moved by the incremental revolutions of parallel turns that move spatially toward each other by electro magnetic attraction, is dependant on the tension of the windings wrapping around the pipedic core. Whereby upon energisation of L2 inductor and the movement of the L2 sensor inductor windings with respect to the stationary auxiliary magnet or auxiliary magnets field, thereto shall actuate the transistor and allow electric current to excite inductor L1 and provide an electro magnetic impulse to the auxiliary magnets. The electro magnetic pulse and corresponding reciprocated auxiliary permanent magnetic field deviation pulses are then detected by the L2 sensor inductor. Such reciprocating magnetic pulse reaction occurs between that of L2 sensor inductor, the auxiliary permanent magnet or auxiliary permanent magnets and L1 impulse inductor are circuited typically by the ferromagnetic core and space.

The oscillatory pulsed magnetic feedback occurring between that of the stationary auxiliary permanent magnets, ferromagnetic core and solenoid coils, have an induced resonant sonic frequency of mechanical vibration throughout the assemblies body comprising of the solenoid assembly and magnetic field modifying assembly. Such vibrations can be conveyed to a rigid body upon the general assemblies physical contact and thereto impose high frequency vibrations upon the rigid body such as a plate form, pipe or chute used to convey fine particulate materials, whereby such sonic mechanical vibrations shall reduce the coefficient of frictional drag and cohesion of a fluidic substance engaged against the surface of such a rigid conveyance form.

Energy transformation is obtained also as Pulsed Frequency Modulated DC electrical power whereby the frequency modulated power take off can be tapped across from the L1 inductor impulse coil and L2 inductive sensor coil.

The pulse frequency modulation of the DC electrical input is induced by the oscillatory pulsed magnetic feedback caused by displacement and vibration of the molecular di-polar magnetic domains occurring within the stationary auxiliary permanent magnets, ferromagnetic core. This induces a resonant sonic frequency having radio frequency harmonics modulating the current within the solenoid coils thereto after an initial kinetic impact to an auxiliary magnet affixed to the ferromagnetic core to undertake excitation of the inductor sensor coil L2. L2 energises the transistor gate to power the impulse coil L1 in which L1 magnetic impulse feeds back to the auxiliary magnet and imposes further molecular vibration in proportion to the natural resonant frequency which was initially established throughout the entire body of the solenoid assembly and magnetic field modifying assembly when struck by a percussive impact force. Furthermore the pulse frequency modulations may be altered by proximity adjustment of a remote auxiliary magnetic placed perpendicular to the longitudinal axis of the inductor coils which the remote auxiliary permanent magnetic field can be used to attenuate or strengthen the primary electro-magnetic field reactions with the coil induction activator auxiliary magnet thereto the aforementioned assembly is further defined by function as a harmonic electro-magnetic pulse frequency modulator to be adapted to a DC electric input whereto obtain a desired modulated voltage and incremental frequency adjustment of electric charge output.

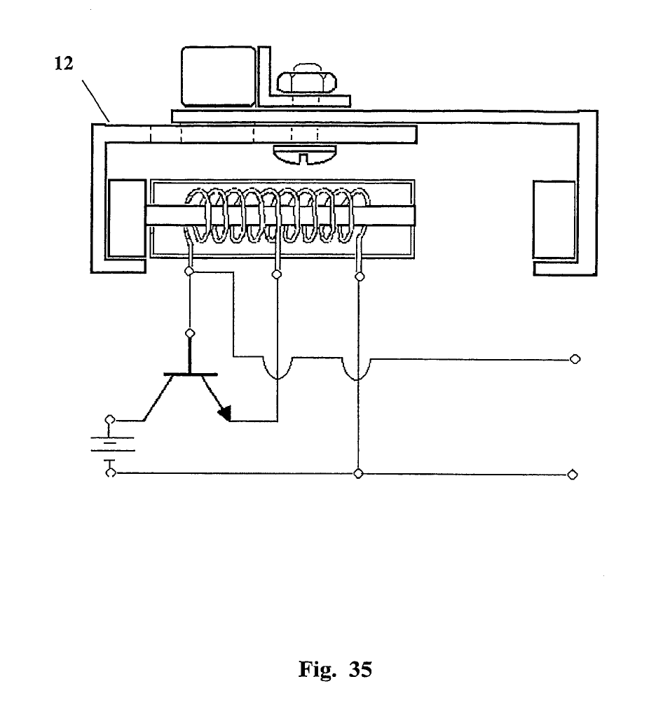

Such incremental pulsed frequencies adjustment of electric charge output are obtained by adjustment of a moveable auxiliary magnet located upon the magnetic field modifying assembly surrounding the aforesaid electric machine whereby the moveable auxiliary magnet may be selectively positioned and fixed by a suitable mechanical restraint whence the desired output frequency modulation and or potential difference is obtained thereto the proximity adjustable remote auxiliary magnet. FIG. 34 illustrates a sixth embodiment in which a further auxiliary permanent magnet 76C is fixed to the body 12 of the assembly 10 shown in FIG. 33. The magnet 76C is held to an L-shaped member 12A which is adjustably fixed onto the body 12 by means screws 12C. To provide a more extensive adjustability, the body 12 can be formed of two telescopically adjustable body sections as shown in FIG. 35.

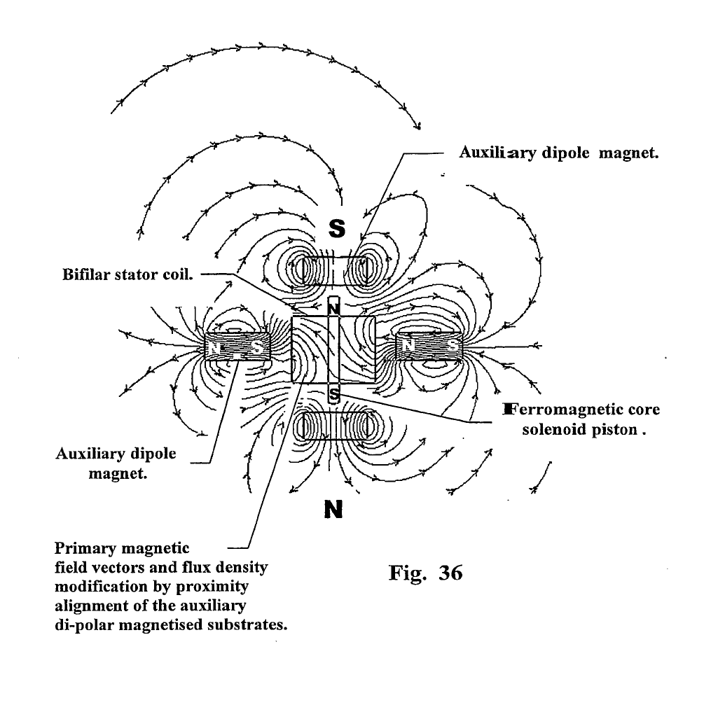

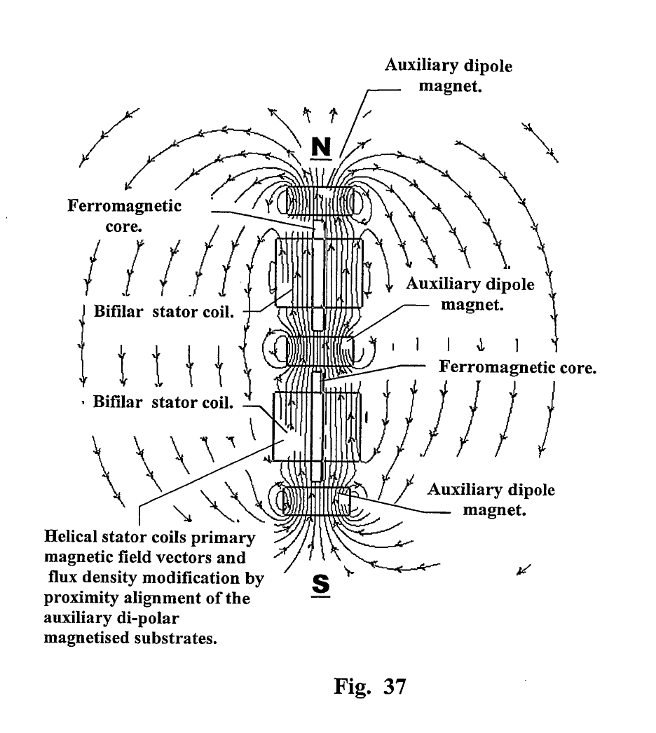

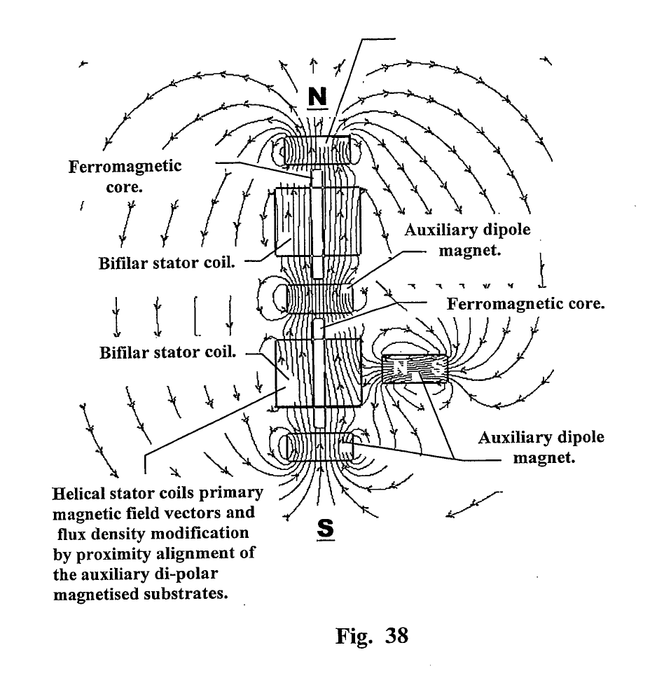

FIGS. 36 to 38 show the respective modified flux densities of certain embodiments of the assembly 10 for modifying the solenoid actuator 7c).

Thus, the assembly 10 provides an improved efficiency of a motor, and allows control of speed and power of a standard motor and/or generator. The assembly 10 can be easily retrofitted to an existing electric machine to modify primary magnetic field thereof for producing a desired output characteristic(s) such as its speed and/or torque if the machine is a motor, or its output power or energy if the machine is a generator/alternator, within a range that is wider than that provided by the existing machine.

The assembly 10 can thus be used to modify or distort the symmetry of a symmetrical or the asymmetry of an asymmetrical primary magnetic field typically generated by an electron excited conductor within close proximity of an isolated magnetic field of the assembly. Such modification may reinforce a primary magnetic field strength by coupling the auxiliary fields to provide polar attraction to the primary magnetic field, whereby such magnetic coupling would result in a greater reaction by virtue of greater flux concentrations to effect reaction fields and the concurrent intrinsic translatory vectors of motion for mechanical take off power. Conversely, it can be arranged to provide polar repulsion to decrease flux concentration.

The assembly enhances the primary magnetic field reactions to obtain suitable translations of motive force for power takeoff and also to effect greater energy conservation by superimposing an auxiliary permanent magnetic field or fields upon the primary reacting magnetic field or fields. Being positionable, it can make adjustments and influence of the primary magnetic reactions by adjusting polar alignment or alignments whereby to make the reacting primary magnetic field exchanges symmetrical or asymmetrical to strengthen or weaken the primary magnetic reacting fields and thereby altering the electromagnetic properties of an electric machine for the purpose of substantially improving the coefficient of output performance and translational energy control such as velocity of rotary motive components intrinsic to electric motors or linear harmonic motion intrinsic to electromagnetic actuators or solenoids. The assembly can thus selectively tune the performance of an electromagnetic machine to undertake varied work loads at the optimum efficiency or greater.

The auxiliary magnetic field or fields can be adjusted to make continuous distortion and fixed deflection of the primary magnetic reacting fields when the electric machine is contained in or in the proximity of the assembly for the purpose of enabling optimum performance at fixed speed and load rating. It can also be used to compensate any deviation from specified machine specifications due to inconsistent manufacturing specifications.

The assembly can be adapted to be integral with or and set fixed within an electric machine, or retrofitted onto an electric machine. Whereby, the auxiliary magnetic influence or auxiliary magnetic influences and associated emanating magnetic fields or field thereof are set permanently to produce a fixed symmetrical or asymmetric auxiliary magnetic field reaction with the primary magnetic influences of a classical electric machine. Whereby, an optimum output characteristic may be obtained and standardized for set efficiency limits for an electric machine.

The assembly can also be adapted for use with AC rectified DC motors or any AC electric machines to enhance performance or as a magnetic field controller to modify primary electromagnetic field reactions of electromagnetic machines. The assembly can be positioned to retard or accelerate the translational motive force and traction generated by such electric machines. It can be retrofitted to operating electric machines which are of reduced efficiency due to loss of permanent magnetic field strength caused by age and heat or weakened flux density generated by an electron excited conductor due to increased resistance caused by corrosion or alternatively excessive heat generated by frictional mechanisms. Such retrofitting requires limited or nil disassembly of the interior mechanisms encased within an existing electric machine.

Whilst the above has been given by way of illustrative example of the present invention many variations and modifications thereto will be apparent to those skilled in the art without departing from the broad ambit and scope of the invention as herein set forth in the claims.

1. An electric machine comprising a magnetic field generating member arranged to generate a primary magnetic field, an armature member arranged to interact with the primary magnetic field and be movable relative to the primary magnetic field generating member, and an magnetic field modifying assembly having an auxiliary magnetic field generating arrangement arranged to be selectively positionable relative to the magnetic field generating member to generate an auxiliary magnetic field to modify the primary magnetic field to thereby cause the armature member interacting with the modified magnetic field to operate at a targeted output characteristic.

2. An magnetic field modifying assembly for an electric machine having a primary magnetic field generating member arranged to generate a primary magnetic field, and an armature member arranged to interact with the primary magnetic field and be movable relative to the primary magnetic field generating member, the assembly comprising an auxiliary magnetic field generating arrangement arranged to be selectively positionable relative to the magnetic field generating member to generate an auxiliary magnetic field to modify the primary magnetic field to thereby cause the armature member interacting with the modified magnetic field to operate at a targeted output characteristic.

3. The invention according to claim 1 wherein the armature being arranged to be rotationally, reciprocally or linearly movable.

4. The invention according to claim 1 wherein the electric machine is a motor and the output characteristic is a targeted speed of movement or torque of the armature member.

5. The invention according to claim 4 wherein the motor is a DC or AC motor, or a DC or AC solenoid actuator.

6. The invention according to claim 1 wherein the electric machine is a generator or alternator, and the output characteristic is an targeted output voltage or power from the armature member.

7. The invention according to claim 1 wherein the electric machine includes a motor having said primary magnetic field generating member and said armature member, and a generator/alternator coupled to said armature member to be driven thereby.

8. The invention according to claim 1 wherein the primary magnetic field generating member being formed of at least one electromagnet and/or at least one permanent magnet.

9. The invention according to claim 1 wherein the electric machine is a solenoid actuator having the primary magnetic field generating member formed as a coil would on a magnetic core, the movable armature member formed as a rod or lever movable relative to the core.

10. The invention according to claim 9 wherein the rod is arranged to be movable in a linear direction or in a pendulum manner.

11. The invention according to claim 1 wherein the magnetic field modifying assembly being configured with a chamber for accommodating said primary magnetic field generating member or said armature member.

12. The invention according to claim 1 wherein said primary magnetic field generating member or said armature member may be formed with a recess for accommodating said magnetic field modifying assembly.

13. The invention according to claim 11 wherein the auxiliary magnetic field generating arrangement is arranged to generate said auxiliary magnetic field in a substantially radial direction towards the chamber/recess.

14. The invention according to claim 9 wherein the magnetic field modifying member being located proximate to the coil or core.

15. The invention according to claim 14 wherein the modifying member is arranged to be selectively positionable relative to the coil or core.

16. The invention according to claim 1 wherein the magnetic field modifying assembly and/or said electric machine are arranged to be adjustably positionable for controllably modifying intensity of said modified magnetic field.

17. The invention according to claim 16 wherein the magnetic field modifying assembly includes a body member configured to support said auxiliary magnetic field generating arrangement and said auxiliary magnetic field generating arrangement including one or more auxiliary permanent magnets arranged to provide said auxiliary magnetic field for modifying intensity of the primary magnetic field, and the body member being arranged to be adjustably positionable so that the position of the auxiliary magnetic field generating arrangement relative to the primary magnetic field generating member is adjustable.

18. The invention according to claim 17 wherein the body member is formed of sections each supporting at least one auxiliary magnetic generating member and the sections are telescopically positionable.

19. The invention according to claim 1 wherein the assembly having a switching member arranged to provide a current path between a power source and said primary magnetic field generating member when the armature member is within a defined region proximate to the primary magnetic field generating member.

20. The invention according to claim 19 wherein the armature member having one or more further permanent magnets arranged to be movable into said region to cause the primary magnetic field generating member to generate a current for switching said switching member to provide said current path, and thereby the primary magnetic field generating member generating said primary magnetic field.

21. The invention according to claim 19 wherein the auxiliary magnetic field generating arrangement having one or more permanents fixed to at least one end of the armature member and is arranged so that an impact force on the one or more permanent magnets causes the primary magnetic field generating member to generate said primary magnetic field for causing said armature to vibrate.

22. The invention according to claim 1 wherein said auxiliary magnetic field generating arrangement having at least one paired auxiliary permanent magnets arranged in an array, and in the array, the or each pair of said paired auxiliary permanent magnets are arranged with their opposite poles in a facing relationship.

23. The invention according to claim 22 wherein the array having one or more tiers of said paired auxiliary permanent magnets arranged in groups of like facing poles such that one group having its north pole(s) facing the south pole(s) of another group.

24. The invention according to claim 11 wherein the body member having said chamber configured therein and the primary magnetic field generating member and/or the armature member being supported in the chamber.

25. The invention according to claim 24 wherein the assembly having a support element for supporting the primary magnetic field generating member and/or the armature member, and the support element being positionable relative to the body member to modify the primary magnetic field.
